(19) United States
(12) Patent Application Publication
(10) Pub. No.: US 2026/0254234 A1
(43) Pub. Date: Aug. 27, 2026

(54) FUEL-CELL INSTALLATION AND METHOD FOR A FUEL-CELL INSTALLATION

(71) Applicant: AVL List GmbH, Graz (AT)

(72) Inventor: Stefan PLANITZER, Frohnleiten (AT)

(73) Assignee: AVL List GmbH, Graz (AT)

(21) Appl. No.: 18/861,895

(22) PCT Filed: Jun. 12, 2023
(86) PCT No.: PCT/AT2023/060182

§ 371 Date: Oct. 31, 2024

(30) Foreign Application Priority Data
Jun. 13, 2022 (AT) A 50412/2022

(51) Int. Cl. H02J 1/12; H01M 8/04537; H01M 8/04664; H01M 8/04858; H01M 8/12; H02J 101/30

(52) U.S. Cl. CPC H02J 1/12; H01M 8/04559; H01M 8/04664; H01M 8/0494; H01M 2008/1293; H02J 2101/30

(57) ABSTRACT

The present invention relates to a fuel cell plant (1) with a fuel cell system (12) comprising a plurality of fuel cell stacks (10), wherein, in order to supply an electrical output network (24) with electrical energy generated by the operation of the fuel cell stacks (10), the fuel cell system (12) is or can be connected electrically with an electrical output network system (20) which comprises an electrical output network (24), characterised in that the fuel cell plant (1) further comprises an electrical power resistor network (50) comprising an electrical power resistor (52) to secure the load point of the fuel cell stacks (10) in the event of a fault, in particular a mains supply fault (104) of the electrical output network system (20), wherein, in order to supply the electrical power resistor network (50) with electrical energy generated by the operation of the fuel cell stacks (10), the fuel cell system (12) is connected electrically to the electrical power resistor network (50).

The present invention relates to a fuel cell plant and a method for securing the load point of fuel cell stacks of a fuel cell system of a fuel cell plant in the event of a fault, in particular a mains supply fault of an electrical output network system.

Applications are known from the prior art in which electrical energy generated by SOFC fuel cell stacks (the abbreviation SOFC stands for “Solid Oxide Fuel Cell”) is fed into an alternating current and three-phase network.

The power dynamics of such fuel cell stacks is low. There are several reasons for this, for example the risk of the cells cracking due to steep temperature gradients that can occur during sudden load variations. Therefore, these fuel cell stacks cannot follow rapid electrical load changes.

In addition to the fuel cell stacks themselves, the fuel cell system as a whole can also be damaged by a sudden load shedding. In this case, the fuel gas cannot be converted into electrical energy and leads, for example, to inadmissible heating of the oxidation catalyst in the fuel cell system and, in the worst case, to complete destruction.

There is also a risk of the fuel gas energy not being converted into electrical energy in the event of a mains supply failure. Requirements regarding grid stability, which are defined by local and so-called “grid codes”, also make a special electrical design necessary for these situations (e.g. so-called low voltage ride through).

It is the object of the present invention to specify a fuel cell plant with a simple, cost-effective electrical design which is optimised in such a way that a fault, in particular a mains supply fault, in particular a power failure, does not result in damage to the fuel cell plant.

The above object is achieved by a fuel cell plant with the features of claim 1 and a method with the features of claim 12. Further features and details of the invention are disclosed in the dependent claims, the description and the drawings. Naturally, features and details described in connection with the fuel cell plant according to the invention also apply in connection with the method according to the invention and vice versa, so that with regard to disclosure mutual reference is or can always be made to the individual aspects of the invention.

According to the invention, a fuel cell plant with a fuel cell system is provided. The fuel cell system comprises a plurality of fuel cell stacks, wherein, in order to supply an electrical output network with electrical energy generated by the operation of the fuel cell stacks, the fuel cell system is or can be connected electrically with an electrical output network system which comprises an electrical output network. The fuel cell plant further comprises an electrical power resistor network comprising an electrical power resistor to secure the load point of the fuel cell stacks in the event of a fault, in particular a mains supply fault of the electrical output network system, wherein, in order to supply the electrical power resistor network with electrical energy generated by the operation of the fuel cell stacks, the fuel cell system is connected electrically to the electrical power resistor network.

Accordingly, according to the invention a fuel cell plant is provided in which the fuel cell stack does not have to deviate from its operating point or load point in the event of a fault, in particular a mains supply fault such as, in particular, a mains supply failure. At the very least, the fuel cell stacks do not have to change their load point beyond the extent, predetermined according to their power dynamics, which can still be considered harmless in terms of the risk of possible damage to the fuel cell system. A mains supply fault is characterised in that only a reduced amount or, in particular in the event of a mains supply failure, no electrical energy can flow into the electrical output network. Such a mains supply failure can for example occur in the event of a short circuit outside of the fuel cell plant. During normal operation, electrical energy generated by the fuel cell stacks is dissipated to the electrical output network, so that this is referred to here as the output network. Alternatively however, it can also be referred to as a feed-in network, for example. Thus, if, due to a mains supply fault, the generated power can no longer be dissipated into the electrical output network, in particular an alternating current and/or three-phase network, the surplus energy can be fed to the electrical power resistor. If the mains supply fault is remedied, the mains voltage returns and the electrical energy can again flow into the electrical output network instead of into the electrical power resistor.

The fuel cell plant according to the invention relates in particular to securing the load point of fuel cell stacks of a fuel cell system of a fuel cell plant in the event of a mains supply fault of an electrical output network, but can also advantageously be used in non-grid-connected systems to secure the load point. All features described in connection with the occurrence of a mains supply fault can therefore also be advantageously applied to non-grid-connected systems.

The fuel cell stacks can most particularly be solid oxide fuel cell stacks. Thus, the fuel cell system can in particular be a solid oxide fuel cell system or solid oxide electrolyser cell system (SOFC system, “Solid Oxide Fuel Cell system). In addition, the individual fuel cell stacks can be electrically connected to each other in parallel, in particular via the electrical intermediate (voltage) circuit, which will be explained in more detail later. Alternatively however, it is also possible to electrically connect individual fuel cell stacks or all of the fuel cell stacks in series.

It is preferable if the electrical power resistor is configured to convert electrical energy into waste heat. In this way, the surplus electrical energy which cannot be dissipated from the fuel cell plant via the electrical output network in the event of a mains supply fault can be removed from the fuel cell plant in an advantageous way, namely as waste heat. Waste heat therefore means in particular that the heat converted from the electrical energy into thermal energy is dissipated. Most particularly, the waste heat is dissipated outside of the fuel cell stack and the fuel cell system. The waste heat is therefore preferably not fed into the fuel cell stacks, which, while this could increase their efficiency, would not be expedient because in this case more electrical energy would then have to be converted into waste heat.

Furthermore, it is preferable if the electrical power resistor is arranged outside of the fuel cell stack. As mentioned above, this is advantageous in order not to use the heat generated by the electrical power resistor in the fuel cell stacks. Instead, installation space outside of the fuel cell system with the fuel cell stacks can advantageously be used for the electrical power resistor network. An optional cooling system can also be better placed and dimensioned in terms of installation space there.

It is thus also preferable if the fuel cell plant includes a cooling unit for cooling the electrical power resistor. The cooling unit can be an air and/or water cooling unit, i.e. it can be configured for cooling by means of air, in particular ambient air, and/or water. In the context of the invention, water is advantageously understood to be any coolant which is in particular liquid. The air can for example be circulated by means of a blower.

The water can be actively cooled by means of a refrigeration unit. This allows a particularly high amount of electrical energy to be dissipated to the electrical power resistor without damaging it, which is particularly advantageous in the event of mains supply failures in which electrical energy can no longer be dissipated via the electrical output network. In principle, it can also be advantageous if the cooling is carried out by natural convection.

It is also advantageous if the electrical power resistor network includes power electronics which are configured to activate the electrical power resistor upon the occurrence of the mains supply fault. Activating the electrical power resistor means feeding the electrical energy generated by the fuel cell system to the electrical power resistor, so that this dissipates the electrical energy, in particular converts it into waste heat or, in other words, converts and dissipates thermal energy.

It is quite particularly preferable if the power electronics are configured to continuously measure a voltage in an electrical intermediate circuit between the fuel cell system and the electrical output network system and to activate the electrical power resistor when a voltage increase occurs in the electrical intermediate circuit. The electrical intermediate circuit can in particular be a DC intermediate circuit. In this way, the power electronics can determine the fault very quickly on the basis of a voltage measurement and any voltage increase that may occur. The electrical power resistor can consequently be activated with minimal time delay following the occurrence of the fault in order to avoid damage to the fuel cell plant. The voltage increase required to activate the power electronics can in particular be predefined. The voltage increase can in particular be predefined as an absolute maximum voltage value and/or as a voltage change over a specified period of time. Consequently, the electrical power resistor can in particular be activated when a continuously measured actual voltage exceeds a predefined maximum absolute voltage value or experiences a specified voltage change within a specified period of time.

Advantageously, the power electronics also have a regulator for regulating the electrical energy supplied to the electrical power resistor depending on the voltage measured in the electrical intermediate circuit. Thus, advantageously, the electrical energy can only be dissipated to the electrical power resistor to the extent required by the extent of the fault, in particular if there is no total failure or mains supply failure. It can also easily be determined when the fault has been remedied and the electrical output network system is available again.

Although the fuel cell system advantageously remains in the operating point when a mains supply fault occurs, it is also advantageous if the fuel cell system is configured to reduce a load point of the fuel cell stacks in operation when the fault, in particular the mains supply fault, occurs. In other words, the operating point of the fuel cell stack can be lowered when the fault, in particular the mains supply fault, occurs. This makes it possible to reduce the electrical energy in the fuel cell plant produced by the fuel cell stacks in order to relieve the electrical power resistor and reduce the resource consumption at the fuel cell stacks. Here too, the aforementioned regulator or another regulator can be used to regulate the load points of the fuel cell stack depending on the voltage measured in particular by the power electronics. A power dynamic of the fuel cell stack can thereby be taken into account, so that the load points of the fuel cell stacks are not reduced beyond their power dynamics in order to avoid damage to the fuel cell stacks. The power dynamics indicate how quickly the load of a fuel cell stack can be reduced without damage. It is therefore an operating specification and can for example be specified by current change rates.

Furthermore, it is advantageous if the electrical power resistor network is arranged in an electrical intermediate circuit between DC/DC converters of the fuel cell stack and a DC/AC converter of the electrical output network system. Accordingly, the aforementioned measurement of the voltage can be carried out in this electrical intermediate circuit, in particular a DC intermediate circuit. The voltage in the electrical intermediate circuit is advantageously regulated to a constant voltage by the electrical output network system. Advantageously, the at least one DC/AC converter thus has an operating mode of constant voltage maintenance in the electrical intermediate circuit. The electrical power resistor network, the DC/DC converters, the fuel cell stack and the DC/AC converter can be arranged parallel to each other. It is possible that each fuel cell stack has a DC/DC converter assigned to it or, in other words, electrically connected to it. It is also possible that several electrical output networks are provided, whereby each electrical output network can have a DC/AC converter. It is also quite particularly possible that the DC/AC converter functions bidirectionally or that two DC/AC converters connected in series are provided which can be unidirectional but work in opposite directions. In this way, electrical energy can if necessary also be drawn from the electrical output network, in particular to supply an electrical system peripherals network during the warm-up and cooling-down phases of the fuel cell stack for the operation of the fuel cell plant.

It is also advantageous if the fuel cell plant includes an electrical system peripherals network comprising system peripherals for supporting an operation of the fuel cell system, wherein, in order to supply the electrical system peripherals network with the electrical energy generated by the operation of the fuel cell stack, the fuel cell system is connected electrically with the electrical system peripherals network. The electrical system peripherals network can also be connected to the electrical intermediate circuit and can in particular be connected in parallel with the electrical power resistor network, the fuel cell system and the electrical output network system. The system peripherals are also known as the “balance of plant”. In particular, the system peripherals may include several or all of the components of the fuel cell system, except for the fuel cell stack itself. These components can for example include pumps, sensors, heat exchangers, seals, compressors, recirculation fans, intercoolers and humidifiers. These are supplied with electrical energy for their operation by the system peripherals network, so that these components can in turn use the normal operation of the fuel cell stack to generate electrical energy. Accordingly, the aforementioned bidirectionality of the DC/AC converter in the electrical output network system is advantageous when starting up and shutting down or, in other words, warming up and cooling down the fuel cell stacks, since the fuel cell stacks themselves typically do not generate any, or not enough, electrical energy to safely supply the system peripherals with electrical energy. Although an electrical storage means can optionally be provided, this represents a cost-intensive investment due to the high capacity required.

The subject matter of the present invention also includes a method for securing the load point of fuel cell stacks of a fuel cell system of a fuel cell plant in the event of a fault, in particular a mains supply fault of an electrical output network system which is supplied with electrical energy generated by the operation of the fuel cell stack. The method has the following steps:
occurrence of the fault, in particular the mains supply fault of the electrical output network system,
determining the fault which has occurred, in particular the mains supply fault, and
converting electrical energy in the fuel cell plant between the fuel cell system and the electrical output network system into waste heat by means of an electrical power resistor.

Thus, a method according to the invention brings the same advantages as have been explained in detail with reference to the fuel cell plant according to the invention.

In particular, the fuel cell plant according to the invention can be configured or designed to carry out the method according to the invention. Conversely, the method according to the invention can in particular be carried out in or by a fuel cell plant according to the invention.

Advantageously, the fault, in particular the mains supply fault, which has occurred can be determined by measuring a voltage increase in an electrical intermediate circuit between the fuel cell system and the electrical output network system.

Also advantageously, the electrical energy converted by the electrical power resistor can be regulated depending on the voltage measured in the electrical intermediate circuit.

Finally, the load points of the fuel cell stacks in operation can advantageously be reduced after the fault, in particular the mains supply fault, has been determined, within the scope of the power dynamics made available by the fuel cell stack. If a power resistor is designed to be sufficiently large, it can also be advantageous if the load point is maintained unchanged.

Further advantages, features and details of the invention are explained in the following description, in which exemplary embodiments are described in detail with reference to the drawings. In each case schematically:

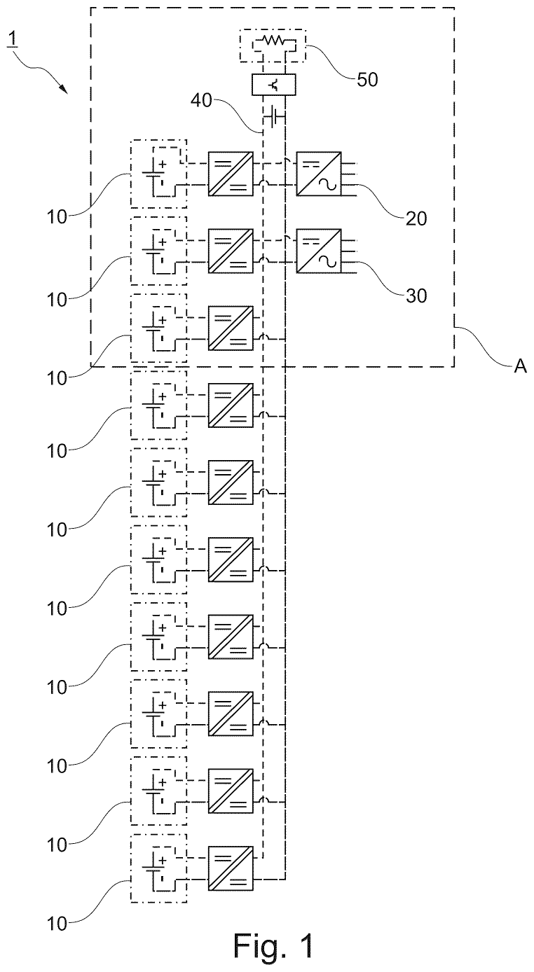

FIG. 1 shows a circuit diagram of a fuel cell plant according to the invention,

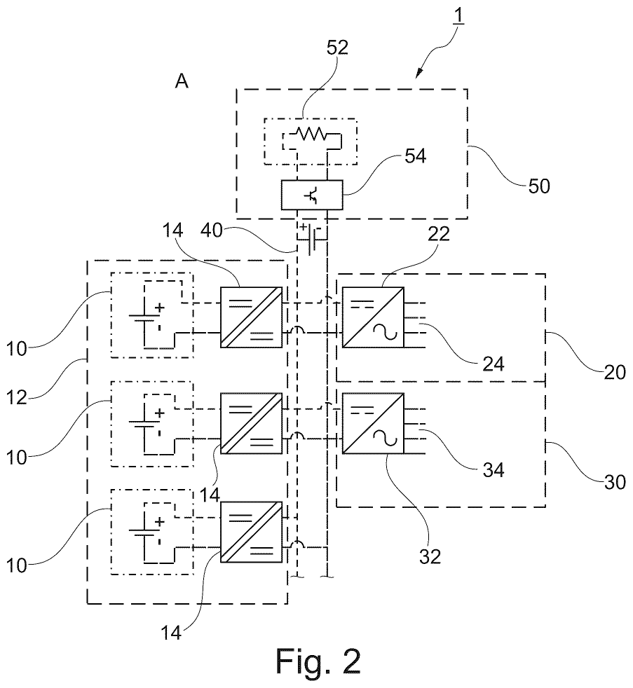

FIG. 2 shows a detail of the circuit diagram of the fuel cell plant from FIG. 1,

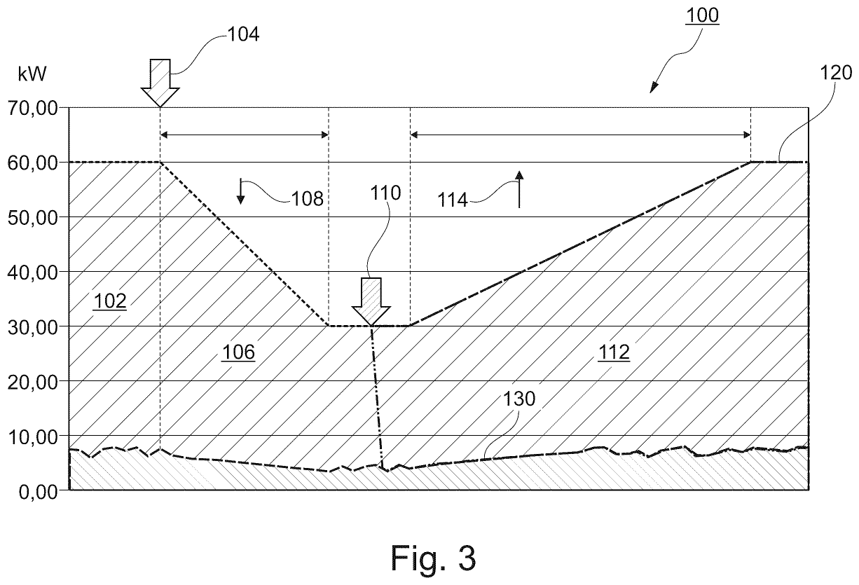

FIG. 3 shows a power curve in the fuel cell plant from FIG. 1, and

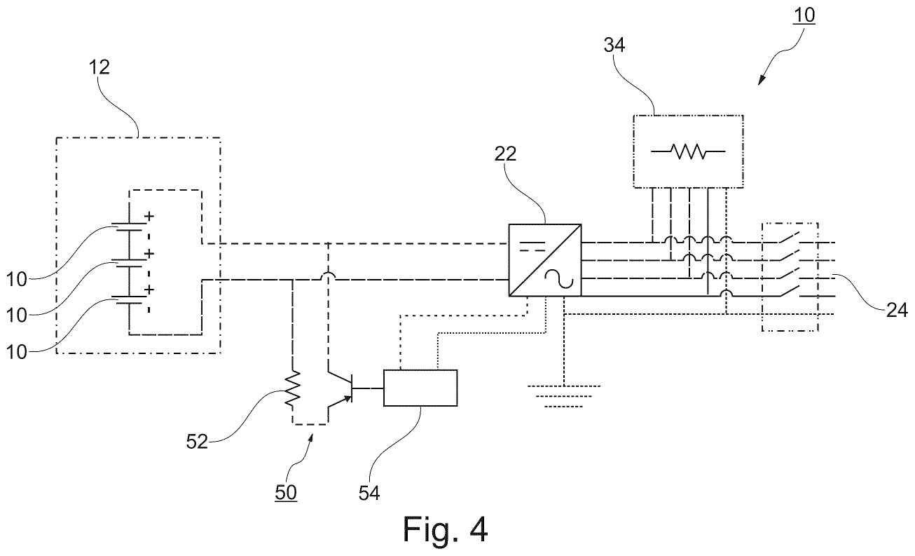

FIG. 4 shows a circuit diagram of an alternative fuel cell system according to the Identical or functionally identical elements are in each case designated with the same reference sign in FIGS. 1 to 4.

FIG. 1 shows a circuit diagram of a fuel cell plant 1 according to an exemplary embodiment of the invention. The fuel cell plant 1 comprises a plurality of fuel cell stacks 10, each of which is connected, in parallel with each other, to an electrical intermediate circuit 40. However, as FIG. 4 shows, as an alternative to the fuel cell plant 1 from FIG. 1, the fuel cell stacks 10 can alternatively be connected in series with each other.

In addition to the fuel cell stacks 10, an electrical output network system 20, an electrical system peripherals network 30 and an electrical power resistor network 50 are each connected in parallel to each other and to the fuel cell stacks 10 by means of the electrical intermediate circuit 40.

FIG. 2 shows the detail of the fuel cell plant 1 of FIG. 1 marked with the letter A in FIG. 1, which by way of example includes ten fuel cell stacks 10, whereby, alternatively, more or fewer fuel cell stacks 10 may also be present. Accordingly, in a detail view FIG. 2 shows only three fuel cell stacks 10 by way of example, whereby the other fuel cell stacks 10 of FIG. 1 are not shown here or, alternatively, can be omitted.

The fuel cell stacks 10 are part of a fuel cell system 12 which also includes a DC/DC converter 14, whereby a DC/DC converter 14 is assigned to each fuel cell stack 10. Each of the fuel cell stacks 10 is electrically connected to the electrical intermediate circuit 40, which in this case is a DC intermediate circuit, by means of one of the DC/DC converters 14.

The electrical output network system 20 has, on the one hand, an AC/DC converter 22 which is connected to an electrical output network 24. The AC/DC converter 22 can in particular be a bidirectional AC/DC converter 22, or alternatively two unidirectional AC/DC converters 22 can be used that work in opposite directions. Depending on the direction of operation of the AC/DC converter, this allows 22 electrical energy or, in other words, electric current to be dissipated from the electrical intermediate circuit 40 to the electrical output network 24 or fed from the electrical output network 24 into the electrical intermediate circuit 40.

The electrical system peripherals network 30 in turn includes system peripherals 34, for example pumps, sensors, heat exchangers, seals, compressors, recirculation fans, intercoolers and/or humidifiers, to support the operation of the fuel cell system 12. The system peripherals 34 are connected to the electrical intermediate circuit 40 via a converter 32. In this case the converter 32 is designed as a DC/AC converter, but alternatively can also be designed as a DC/DC converter.

The electrical power resistor network 50 has an electrical power resistor 52 and power electronics 54 which are electrically connected to the electrical intermediate circuit 40. The power electronics 54 can in turn have various components, such as, in particular, a voltage meter for measuring the voltage in the electrical intermediate circuit 40 and/or a regulator for regulating the electrical energy supplied to the electrical power resistor 52 from the electrical intermediate circuit 40.

FIG. 3 shows the sequence of an exemplary method 100 according to an embodiment of the invention on the basis of a fuel cell system power curve 120 of the power in kW over the time of the fuel cell system 12 and a system peripherals network power curve of the power in kW over the time of the system peripherals network 30.

In a first step 102 of the method, the fuel cell system 12 is operated at full power and in this case by way of example delivers 60 KW (see fuel cell system power curve 120 within the time range of the first step 102). Part of this power output of the fuel cell system 12 is provided to the electrical system peripherals network 30, as can be seen from the system peripherals network power curve 130.

Now it is assumed that, as the second step of the method 100, a mains supply fault 104 occurs, in particular a mains supply failure, in the electrical output network 24, so that the electrical output network 24 can no longer consume electrical energy from the electrical intermediate circuit 40. This occurrence of the mains supply fault 104 can advantageously be determined by the power electronics 54, which through its voltage meter detects a voltage in the electrical intermediate circuit 40 that exceeds a predefined maximum voltage for a mains supply fault 104, so that the mains supply fault 104 is determined.

In a third step 106 of the method 100, the electrical power resistor 52 is then activated by the power electronics 54. The electrical energy in the electrical intermediate circuit 40, which continues to be generated by the fuel cell system 12 and fed into the electrical intermediate circuit 40, is now fed to the electrical power resistor 52, which converts it into waste heat. This conversion takes place outside of the fuel cell system 12. The electrical power resistor 52 is advantageously cooled, particularly advantageously water-cooled, during its operation.

Parallel to or following the third step 106, a fourth step 108 of the method 100 is initiated in which the load points of the fuel cell stacks 10 in operation are reduced, within the scope of the power dynamics available from the fuel cell stack 10, after the mains supply fault 104 has been determined. As a result, the electrical energy generated by these decreases over time, as can be seen from the fuel cell system power curve 120 in the time range of the third step 106. This means that less electrical energy has to be dissipated from the electrical intermediate circuit 40 to the electrical power resistor 52.

If the mains supply fault 104 is remedied, network recovery 110 of the electrical output network 24 occurs at a certain point in time as the fifth step of the method 100. The electrical output network 24 is now available again for feeding electrical energy from the electrical intermediate circuit 40.

Accordingly, according to a sixth step 112 of the method 100 the electrical energy is again fed to the electrical output network 24 instead of the electrical power resistor 52. The electrical power resistor 52 can therefore be switched off by the power electronics 54. The network recovery 110 can also be determined through voltage measurement by the power electronics 54. Parallel to or following the sixth step 112, a seventh step 114 of the method 100 is carried out in which the load points of the fuel cell stacks 10 in operation are ramped up again within the scope of the power dynamics available from the fuel cell stack 10 after the network recovery 110 has been determined.

FIG. 4 shows an alternative embodiment of a fuel cell plant 1 in which the fuel cell stacks 10 of the fuel cell system 12 are connected to each other in series. In addition, a common DC/AC converter 22 is used for the electrical output network 24 and the system peripherals 34.

Above all, however, the electrical power resistor 52 is not arranged in an electrical intermediate circuit 40, but between the DC connections of the fuel cell stacks 10 and the DC/AC converter 22. The power electronics 54, which are responsible for controlling and/or regulating the electrical power resistor 52, are advantageously part of the DC/AC converter 22.

The electrical power resistor 52 can therefore be connected either directly to the DC terminals of the fuel cell stacks 10 or to an electrical intermediate circuit 40, as shown in FIGS. 1 and 2. A control loop can be implemented on a separate control unit with transistor switches for the electrical power resistor or on a central control unit.

The above explanations of the embodiments describe the present invention exclusively in the context of examples.

### LIST OF REFERENCE SIGNS

1 fuel cell plant

10 fuel cell stack

12 fuel cell system

14 DC/DC converter

20 electrical output network system

22 DC/AC converter (of the electrical output network system)

24 electrical output network

30 electrical system peripherals network

32 converters (electrical system peripherals network)

34 system peripherals

40 electrical intermediate circuit

50 electrical power resistor network

52 electrical power resistor

54 power electronics

100 method

102 first step

104 mains supply fault

106 third step

108 fourth step

110 network recovery

112 sixth step

114 seventh step

120 fuel cell system power curve

130 system peripherals network power curve

1-15. (canceled)

16. Fuel cell plant (1) with a fuel cell system (12), comprising a plurality of fuel cell stacks (10), wherein, in order to supply an electrical output network (24) with electrical energy generated by the operation of the fuel cell stacks (10), the fuel cell system (12) is or can be connected electrically with an electrical output network system (20) which comprises an electrical output network (24), wherein the fuel cell plant (1) further comprises an electrical power resistor network (50) comprising an electrical power resistor (52) to secure the load point of the fuel cell stacks (10) in the event of a fault, in particular a mains supply fault (104) of the electrical output network system (20), wherein, in order to supply the electrical power resistor network (50) with electrical energy generated by the operation of the fuel cell stacks (10), the fuel cell system (12) is connected electrically to the electrical power resistor network (50), wherein the electrical power resistor network (50) is arranged in an electrical intermediate circuit (40) between DC/DC converters (14) of the fuel cell stacks (10) and a DC/AC converter (22) of the electrical output network system (20), wherein the DC/AC converter (22) is bidirectional and is connected to the electrical output network (24), so that electrical energy from the electrical intermediate circuit (40) can be dissipated to the electrical output network (24) and fed from the electrical output network (24) into the electrical intermediate circuit (40).

17. Fuel cell plant (1) according to claim 16, wherein the electrical power resistor (52) is configured to convert electrical energy into waste heat.

18. Fuel cell plant (1) according to claim 16, wherein the electrical power resistor (52) is arranged outside of the fuel cell stack (12).

19. Fuel cell plant (1) according to claim 16, wherein the fuel cell plant (1) includes a cooling unit for cooling the electrical power resistor (52).

20. Fuel cell plant (1) according to claim 16, wherein the electrical power resistor network (50) comprises power electronics (54) which are configured to activate the electrical power resistor (52) upon the occurrence of the mains supply fault (104).

21. Fuel cell plant (1) according to claim 20, wherein the power electronics (54) are configured to continuously measure a voltage in an electrical intermediate circuit (40) between the fuel cell system (12) and the electrical output network system (20) and to activate the electrical power resistor (52) when a voltage increase occurs in the electrical intermediate circuit (40).

22. Fuel cell plant (1) according to claim 21, wherein the power electronics (54) have a regulator for regulating the electrical energy supplied to the electrical power resistor (52) depending on the voltage measured in the electrical intermediate circuit (40).

23. Fuel cell plant (1) according to claim 16, wherein the fuel cell system (12) is configured to reduce a load point of the fuel cell stacks (10) in operation when the fault occurs.

24. Fuel cell plant (1) according to claim 16, wherein the fuel cell plant (1) includes an electrical system peripherals network (30) comprising system peripherals (34) for supporting an operation of the fuel cell system (12), wherein, in order to supply the electrical system peripherals network (30) with the electrical energy generated by the operation of the fuel cell stack (10), the fuel cell system (12) is connected electrically with the electrical system peripherals network (30).

25. Method (100) for securing the load point of fuel cell stacks (10) of a fuel cell system (12) of a fuel cell plant (1) according to claim 16 in the event of a fault in an electrical output network system (20) which is supplied with electrical energy generated by the operation of the fuel cell stack (10), wherein the method (100) is characterised by the following steps:
occurrence of the fault, in particular the mains supply fault (104) of the electrical output network system (20),
determining the fault which has occurred, in particular the mains supply fault (104), and
converting electrical energy in the fuel cell plant (1) between the fuel cell system (12) and the electrical output network system (20) into waste heat by means of an electrical power resistor (52).

26. Method (100) according to claim 25, wherein the fault which has occurred, in particular the mains supply fault (104), is determined through a measurement of a voltage increase in an electrical intermediate circuit (40) between the fuel cell system (12) and the electrical output network system (20).

27. Method (100) according to claim 26, wherein the electrical energy converted by the electrical power resistor (52) is regulated depending on the voltage measured in the electrical intermediate circuit (40).

28. Method (100) according to claim 25, wherein the load points of the fuel cell stacks (10) in operation are reduced after the fault, in particular the mains supply fault (104), has been determined, within the scope of the power dynamics made available by the fuel cell stack (10).
